(19) United States
(12) Patent Application Publication
(10) Pub. No.: US 2006/0073833 A1
(43) Pub. Date: Apr. 6, 2006

(54) Frequency allocation in communication network

(75) Inventors: Jyri Hamalainen, Oulu (FI); Esa Tiirola, Oulu (FI); Jari Hulkkonen, Oulu (FI); Mikko Saily, Sipoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/239,293

(22) Filed: Sep. 30, 2005

(30) Foreign Application Priority Data
Oct. 1, 2004 (FI) 20045368

(51) Int. Cl. H04Q 7/20

(52) U.S. Cl. 455/447

(57) ABSTRACT

A radio network element, comprising means for communicating, in a first coverage area, with a mobile terminal applying a primary frequency, means for communicating, in the first coverage area, with the mobile terminal by applying one or more secondary frequencies, if the mobile terminal can support and requests for one or more secondary uplink frequencies, wherein the radio network element is configured to allocate the primary frequency and one or more secondary frequencies from a set of frequencies, the set of frequencies being the same set of frequencies available for allocation in a second coverage area next to the first coverage area, wherein an allocation priority of the frequencies in the set of frequencies is different in the first coverage area compared to an allocation priority of frequencies in the second coverage area.

### FIELD

The invention relates to a method, a network, a network element, a micro or pico cell base station, a terminal and a software product for providing allocation of frequencies in a mobile communication network.

### BACKGROUND

Multi-carrier technology is very likely to form a basis for future radio technologies in so called 3.5^{th} and 4^{th} generation radio networks. One example of a multi-carrier system is the OFDM (Orthogonal Frequency Division Multiplexing) system, wherein data is transmitted by dividing it into several interleaved bit streams that are used to modulate several carriers.

Multi-carrier systems, however, pose problems for frequency planning due to the fact that terminals using several frequencies or frequency bands cause both intra-cell and inter-cell interference. Therefore, an effective solution for dynamic frequency-planning in a mobile network and use of such a network is called for.

### SUMMARY

An object of the invention is to provide a method, a radio network, a radio network element, a micro or pico cell base station and a mobile terminal to alleviate the aforementioned problem and provide an efficient manner to use frequencies in a radio network.

In one aspect of the invention, there is provided a method of allocating frequencies on the uplink of a radio network, the method including allocating a same set of uplink frequencies to be used in two adjacent coverage areas of the network, wherein the set of uplink frequencies is allocated according to a different allocating priority in the two adjacent coverage areas.

In another aspect of the invention, there is provided a radio network, wherein the network is configured to use a same set of uplink radio frequencies in two adjacent coverage areas of the network, and wherein the network is configured to allocate the uplink frequencies in the adjacent coverage areas according to a different allocation priority.

In still another aspect of the invention, there is provided a radio network element, comprising means for communicating, in a first coverage area, with a mobile terminal applying a primary frequency, means for communicating, in the first coverage area, with the mobile terminal by applying one or more secondary frequencies, if the mobile terminal can support and requests for one or more secondary uplink frequencies, wherein the radio network element is configured to allocate the primary frequency and one or more secondary frequencies from a set of frequencies, the set of frequencies being the same set of frequencies available for allocation in a second coverage area next to the first coverage area, wherein an allocation priority of the frequencies in the set of frequencies is different in the first coverage area compared to an allocation priority of frequencies in the second coverage area.

In still another aspect of the invention, there is provided a micro or pico cell base station, comprising means for providing a radio cell, wherein the radio cell is in an operation area of a macro cell, the micro or pico cell base station being configured to use a same set of frequencies as a macro cell network, wherein an allocation priority of the frequencies in the micro or pico cell base station is such that a primarily allocated frequency of the macro cell has a lowest allocation priority in the micro or pico cell.

In still another aspect of the invention, there is provided a mobile terminal, comprising means for setting up a first uplink connection to a mobile network, means for evaluating at least one property associated with the first uplink connection, and means for deciding upon the at least one property whether one or more second uplink connections can be set up to the network.

In still one aspect of the invention, there is provided a computer program product encoding a computer program of instructions for executing a computer process of allocating frequencies on the uplink of a radio network, the process including allocating a same set of uplink frequencies to be used in two adjacent coverage areas of the network, wherein the set of uplink frequencies is allocated according to a different allocating priority in the two adjacent coverage areas.

The network according to the invention operates on at least two separate frequencies in uplink transmission. In one embodiment, the separate frequencies refer to frequency sub-bands of an MC-WCDMA (Multi-Carrier Wideband Code Division Multiple Access) network. Such a network can employ three separate 5 MHz carriers, for instance. In another embodiment, separate frequencies refer to groups of sub-carriers of a certain frequency band, such as those used in an OFDMA or MC-CDMA system, for instance.

In the mobile network according to the invention, the network comprises at least one base station. Each base station receives uplink transmission in receiving coverage areas. In the invention, there is provided a method and a system of allocating uplink frequencies so that a set of uplink frequencies is reused so that the allocation priority of the set of uplink frequencies is different in the two adjacent coverage areas. In conjunction with the disclosure of the invention, the coverage area can mean a segment of a network that is formed by using a directional transceiver, which is often called as a sector. In some networks, such as in 3G networks, term cell is used for the sector as defined above. In such a context, the coverage area according to the invention thus means a cell.

In the invention, two adjacent sectors, either provided by a single base station or two base stations, utilize the same set of uplink frequencies. For instance, two adjacent coverage areas can use frequency bands F1 and F2. In the first coverage area, the frequency band F1 is a primary frequency band, meaning that an uplink frequency is allocated first to a terminal from band F1. A secondary frequency in the first coverage area is allocated from the frequency band F2. In the second coverage area, the allocation priority is reverse, that is, the primary frequency band is F2 and the secondary frequency band is F1.

By the frequency allocation method and system of the invention, interference in a network is suppressed in a controlled way. At the same time, use of full band and maximum achievable data rates is allowed.

### DRAWINGS

In the following, the invention will be described in greater detail by means of embodiments and with reference to the attached drawings, in which

FIG. 1 shows power distribution among frequencies in a transmitter;

FIG. 2 shows one embodiment of a network configuration method;

FIG. 3 shows one embodiment of a network usage method;

FIG. 4 shows one embodiment of frequency allocation according to the invention;

FIG. 5 shows another embodiment of frequency allocation according to the invention;

FIG. 6 shows still another embodiment of frequency allocation according to the invention;

FIG. 7 illustrates one embodiment of a network according to the invention.

### EMBODIMENTS

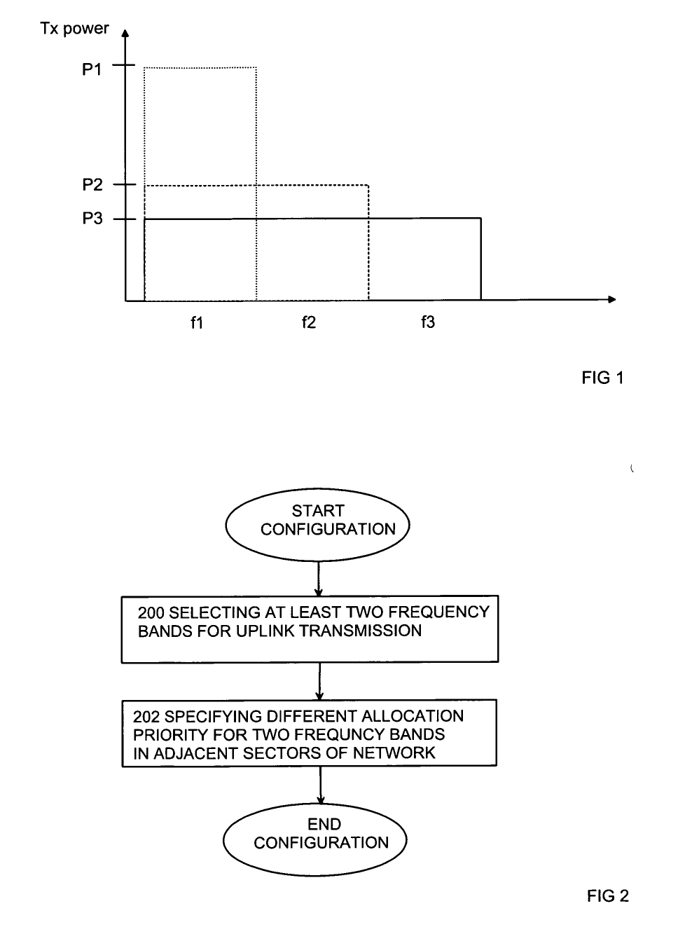

Mobile terminals have a limited transmission power and, in fact, can employ several carriers or groups of sub-carriers in uplink transmission only close to a base station. FIG. 1 illustrates a mobile terminal's power usage in case of one, two or three frequencies. Power level P1 indicates the power level a mobile can reach when using only one carrier f1.

As the figure shows, the power level is high and the mobile could thus also reside far from the base station. When a second carrier f2 is taken into use in addition to the first frequency f1, the mobile's transmission power is evenly divided between the carriers f1 and f2. Correspondingly, when three frequencies f1, f2 and f3 are allocated to the terminal for uplink transmission, the power is equally distributed among them. Thus, it is clear that when several frequencies/carriers are utilized in the mobile terminal, the terminal cannot reside far from the serving base station in view of sufficiency of the transmission power.

In one embodiment of the invention, the network is a UMTS (Universal Mobile Telecommunication System) network applying WCDMA technology. In the following, the structure of the UMTS network is shortly discussed.

The WCDMA can structurally be divided into a core network (CN), a UMTS terrestrial radio access network (UTRAN), and user equipment (UE). The core network and the UTRAN are part of a network infrastructure of the wireless telecommunications system.

The core network includes a serving GPRS support node (SGSN) connected to the UTRAN over an lu PS-interface. The SGSN represents the center point of the packet-switched domain of the core network, and the main task of the SGSN is to transmit/receive packets to/from user equipment that is using the UTRAN. The SGSN may contain subscriber and location information related to the user equipment.

The UTRAN can include at least one radio network subsystem (RNS), each of which includes at least one radio network controller (RNC) and at least one Node B controlled by the RNC. The Node B implements the Uu-radio interface, through which the user equipment may access the network infrastructure.

The user equipment or the mobile terminal may include two parts, that is, mobile equipment and a UMTS subscriber identity module (USIM). The mobile equipment includes radio frequency parts for providing the Uu-interface. The user equipment can further include a digital signal processor, memory, and computer programs for executing computer processes. The user equipment may further include an antenna, a user interface, and a battery. The USIM comprises user-related information and information related to information security, such as an encryption algorithm.

FIG. 2 illustrates one embodiment of the network configuration method according to the invention. In the first step 200 of the method, there are at least two frequency bands that can be selected for uplink use in the network. In a WCDMA network, there could be two separate 5 MHz bands, for instance.

In the example of FIG. 2, there are two sectors for which frequencies have to be allocated. The two sectors can belong to the operating area of one base station or to operating areas of different base stations. Here, by adjacent it is meant that two sectors have a common border or are at least partly overlapping each other. According to step 202, the two frequency bands are allocated in a different allocation priority in the two adjacent sectors. That is, if the two frequency bands are denoted by f1 and f2, the first sector has an allocation priority, that is, frequency filling list (FFL) f1-f2, whereas sector two has an allocation order f2-f1. In the following disclosure of the invention, the frequency that is allocated first is called a primary frequency. Frequencies that are allocated after the primary frequency are called secondary frequencies. The frequency allocated as second is thus the first secondary frequency and the frequency allocated third is called a second secondary frequency.

In one embodiment, the network according to the invention is an OFDM network. The OFDM network applies a certain frequency band. The frequency band can be divided into frequency sub-carriers.

In an OFDM transmitter, an OFDM waveform can be created from the modulated data by applying IFFT (Inverse Fast Fourier Transform). The principal modulation method used for data modulation can be for instance PSK (Phase Shift Keying) or QAM (Quadrature Amplitude Modulation).

The created waveform contains frequency distributed baseband data corresponding to sub-bands of the OFDM signal. The waveform contains several waves where each wave represents a sub-band signal. The number of waves in the basic waveform depends on parameters given to IFFT transformation. Typically, the waveform consists of 2 to 4 waves but it can also contain more than four waves. Each wave corresponds to a sub-carrier transmitted in the network. Thus, in OFDM, several narrowband carriers are transmitted from the same source in parallel at different frequencies. With regard to the invention, the concept “frequency” can include a group of sub-carriers transmitted on the uplink. Thereby, the groups of sub-carriers applied in adjacent cells are equal to each other but their allocation order is different in the adjacent cells.

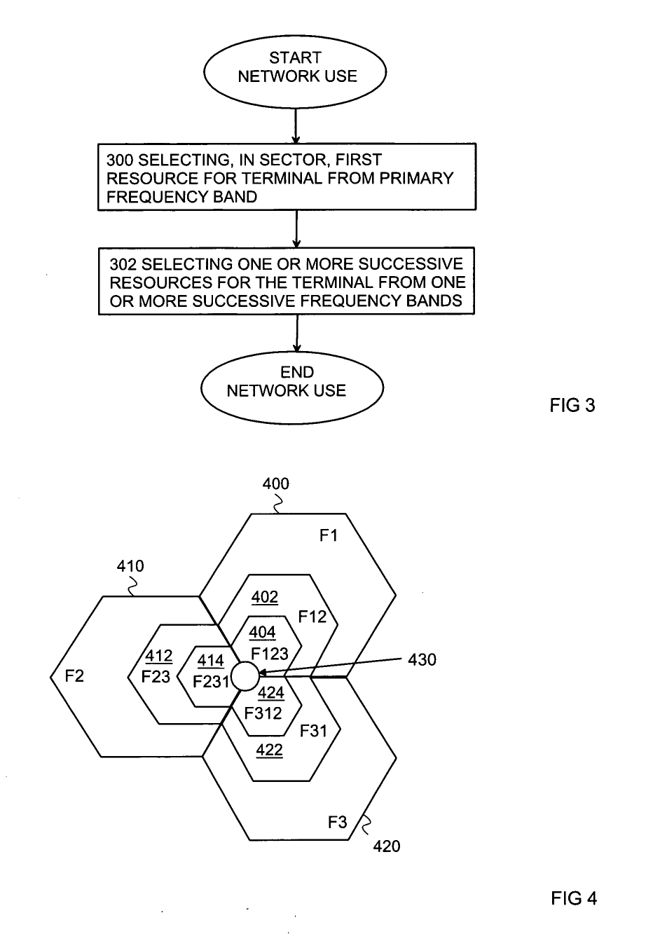

FIG. 3 illustrates frequency usage in a network that has been configured according to the method of FIG. 2. Assuming that a terminal resides in the first sector, the first uplink frequency needed for the terminal, that is, the primary frequency, is allocated from frequency band f1 according to step 300. The second uplink frequency, that is, the first secondary frequency, is allocated from frequency band f2 according to step 302. In the second sector, the reverse applies and thus the primary frequencies in the two adjacent sectors are different. This is reflected to the allocation order of secondary frequencies, and also their allocation order is different in two adjacent sectors, whereby the allocation order of frequencies in the first sector and the second sector are completely different in comparison to each other. Thereby, the network can apply a reuse scheme 1, which means that all frequencies can be reused in neighbouring sectors.

As one example of the usage and allocation of network frequencies, we may consider a situation where initially a mobile terminal (MT) is using frequency F1 for speech and data services but desires to launch a high data rate service for which it needs an additional frequency. For that purpose the MT can check the mean transmit power that is used on a primary frequency band. Additionally, if power control is applied, variation of the transmit power is checked. The terminal can then estimate the applied transmit power per an information bit on the primary frequency. Next, the terminal can estimate the required total transmit power if an additional frequency is introduced with a desired data service. A decision is then made in the terminal as to whether or not it can use a secondary frequency. If it is clear that there is not enough transmission power available in the terminal, no secondary frequency is introduced and the desired data service is blocked. If enough transmission power is available, an additional frequency is introduced.

The decision whether or not to introduce an additional frequency can also take into account the coding and modulation alternatives that are available. If link adaptation is applied, the number of applied frequency bands/groups of sub-bands can be selected on the throughput basis. Here throughput is a measure for an error free information rate between a mobile terminal and a base station.

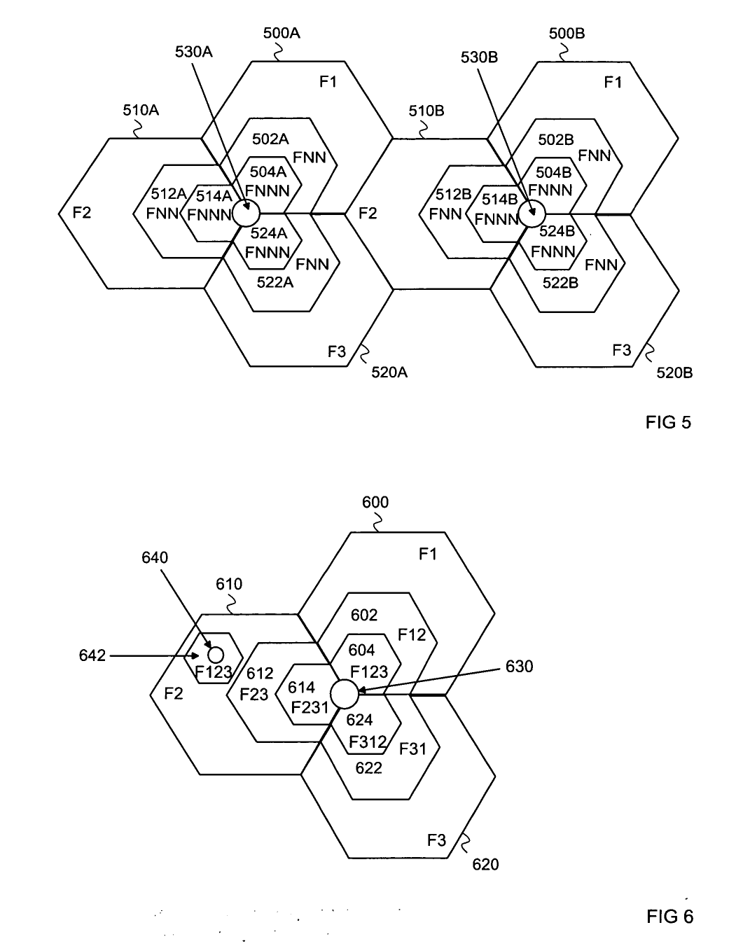

FIG. 4 further illustrates one embodiment of configuration and allocation of frequencies in a mobile network on the uplink. A base station 430 has in uplink three operating areas, that is, sectors 400, 410 and 420. Three frequency bands F1, F2 and F3 are in use in the network. F1 is a primary frequency band used in sector 400 and frequency bands F2, and F3 are primary frequency bands in sectors 410 and 420, respectively.

FIG. 4 also shows smaller areas 402 and 404 within a cell area 400. Area 402 illustrates, with reference to FIG. 1, an area in which mobiles have transmission power for two uplink frequencies. The sector area 404 shows an area in which a mobile is able to apply three frequencies in view of transmission power. The sizes of the areas 402 and 404 are not necessarily fixed in the network but can vary dynamically depending on the interference situation, for instance. When there is a lot of traffic in the network, the areas 402 and 404 can be smaller. When there is less traffic in the network, the usage areas of the first and second secondary frequencies can be expanded.

The primary frequency band in the case of cell 400, for instance, is the frequency band that is allocated first to a mobile that resides outside the cell area 402 in the cell 400. If a mobile resides within the cell area 402 and requests additional frequencies in addition to the frequency already allocated from frequency band F1, frequency band F2 is utilized. Consequently, a mobile that resides in or moves into the cell area 404 can first be given uplink frequencies from frequency band F1, then from band F2 and finally from band F3. Respectively, a mobile that is in a sector area 412, is given uplink frequencies primarily from frequency band F2 and secondarily from frequency band F3. Frequency band F1 is not used in the sector area 412. However, when the terminal moves closer to a base station into the cell area 414, frequency band F1 can also be used as a tertiary frequency pool. A terminal residing in a sector 424 obtains uplink frequencies in an allocation order F3, F1 and F2.

FIG. 5 illustrates frequency reuse in a network including two base stations 530A and 530B. The network according to FIG. 5 applies fixed frequency reuse for the primary frequencies such that F2 is reused for sectors 510A and 510B residing on the left from the respective base stations 530A and 530B, for instance. It can be seen that the primary frequency is not repeated in the two adjacent sectors.

FIG. 5 also shows that, in one embodiment of the invention, FFL's are partly or completely dynamic and they may change according the interference situation in the network. The notation FNN means that two out of three frequencies can be used in a selected order. Correspondingly, FNNN means that all three frequency bands can be utilized in a selected order.

In one embodiment, the interference in a radio network can be determined from measurement reports that are received from the mobile terminals using the network. That is, the mobile terminals measure the quality of downlink transmission and send corresponding measurement reports to the serving base stations.

In another embodiment, the network is configured to determine the interference situation in a network from measurement reports that are formed in base stations of the network. For instance, the base stations in the network can convey the measurement reports to a base station controller, which determines frequencies suitable to be applied in the base stations.

In one embodiment, a network is configured to determine the interference situation in the network from measurement reports that are formed in both the mobile terminals using the network and in the base stations of the network.

In still one embodiment, a radio network is configured to determine the interference situation in the network from information obtained from allocation of frequencies in the network. That is, in such a case the interference situation is indirectly utilized in allocation of frequencies. If a certain frequency is rarely allocated in a sector/sub-sector, the network can from this allocation information conclude that the particular frequency is interference-prone in this area and will not allocate that frequency for uplink use.

An interference estimate in a base station can be formed by directly using information measured from uplink, thereby ensuring that the allocated uplink channel is good enough. In addition, the interference situation can be estimated by information that is measured from downlink and signalled to the base station. Measured downlink information indicates the neighbouring cells that the connection interferes with, if the same frequency is put to use. This “two-way check” is to ensure that a newly allocated channel will not cause too much interference for other existing connections in the neighbouring cells. In such a two-way check, also a radio resource situation, e.g. cell load information, from the neighbouring cells can be used for estimating the interference situation between the cells.

The dynamic frequency allocation principle in FIG. 5 means that in a section of a sector, that is, a sub-coverage area 522A, for instance, two frequencies out of three frequencies F1/F2/F3 can be utilized. The allocation order of the frequencies is not fixed and thus, for instance, in sector 502A, also frequencies F2 and F3 can be allocated for uplink use in contrast to the corresponding situation in FIG. 4, wherein frequencies F1 and F2 can be allocated in that order in the area 402. Correspondingly, in sector areas 504A, 514A and 524A, all the frequencies F1, F2 and F3 can be allocated dynamically.

In the case of dynamic use of frequencies, the areas where certain frequencies are used may exceed the sector or cell boundaries. In one embodiment, the primary frequencies have a fixed reuse scheme, whereas one or more secondary frequencies can be allocated dynamically. Hence, different mobiles within the same sector can have different FFL's.

FIG. 6 illustrates one further embodiment of the invention. A macro cell network comprising a base station 630 includes a micro/pico cell base station 640 within a sector area 610 so that the two networks have overlapping coverage areas. The primary frequency in sector 610 is F2 and thus dominant interference into the micro cell network is expected to come from frequency band F2. Thus, the micro cell network can use initial FFL (F1, F3, F2), whereby the most interfering frequency band F2 will be allocated last in the micro cell network. The FFL in the micro cell network can be dynamically changed according to interference conditions.

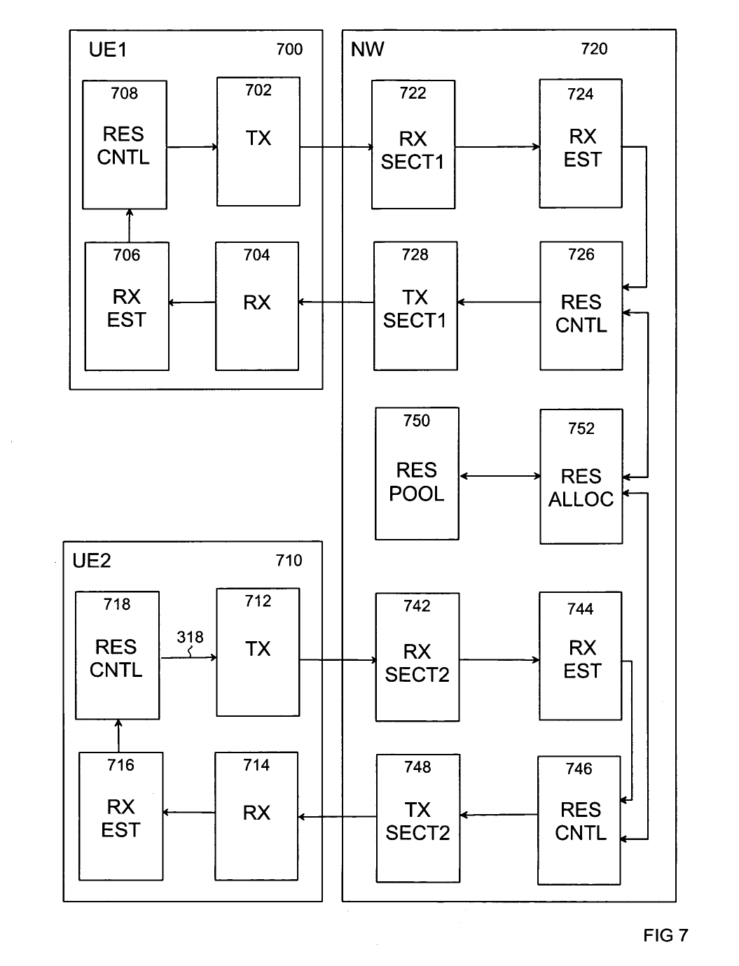

FIG. 7 illustrates one embodiment of a network according to the invention. In FIG. 7, user equipment (UE1 and UE2) 700 and 710 is connected to the network 720 in different sectors. The sectors can belong to a single base station or they can belong to two different base stations.

The user equipment UE1 comprises means for transmitting 702 an uplink signal on one or more carriers. UE1 also comprises means for receiving 704 a downlink signal. In one embodiment of the invention, user equipment comprises means for estimating 706 the quality of uplink transmission. The estimating means 706 can, according to one embodiment, receive a quality estimate of the uplink in downlink transmission from the network 720. The quality estimate can include information on the receiving power of the uplink signal in a base station, for instance, or alternatively it can include a signal quality value such as signal-to-interference ratio that is measured in the base station. The estimating means 706 can convey the information about signal quality to frequency controlling means 708. The frequency controlling means 708 can, upon the information measured or received by the estimating means 706, decide whether the user equipment could be able to transmit using additional frequencies. In making the decision, the estimating means can perform consideration in view of transmission power, for instance. Then, the estimating means can assess whether the total available transmission power could be divided between the earlier and a possible new uplink resource such that the power level for each resource still exceeds a predetermined power threshold, for instance. A need for additional resources originates from the user's needs. For instance, additional uplink resources may be needed for a temporary need of transmitting a picture file towards another mobile subscriber.

The user equipment UE2 comprises the same functionality as disclosed above in view of UE1. UE2 can reside in the coverage area of the same base station as UE1, but is in a different sector than UE1. Alternatively, the two sets of UE are in the coverage areas of different base stations.

FIG. 7 also discloses a mobile network 720 providing at least two receiving sectors on the uplink. The first receiving means 722 is configured to receive in uplink in sector 1. Estimating means 724 evaluate the received signal. For instance, the estimating means can estimate the receiving power of the received signal. Alternatively, the estimating means 724 can estimate the power of the received signal in comparison to other signals received by the base station. In one embodiment, the estimating means 724 can evaluate the distance between a terminal 700 and a base station. Thus, the estimating means can be partly or completely situated in a radio network controller that has control over several base stations.

FIG. 7 also shows a resource controller 726, which can be in charge of controlling resources in a base station, for instance. The resource controller 726 can furthermore be connected to a network resource allocating means 752 that can handle uplink resources on a network level. The allocating means 752 can be configured to handle dynamic channel allocation of resources, for instance. A resource pool 750 includes resources that can be allocated in the network. In an aspect of the invention, uplink resources that can be allocated for neighbouring sectors are the same. The network also includes transmitting means 728 for transmitting a downlink signal towards one or more terminals in the coverage area of the transmitting means. In view of the invention, the downlink signal can include information, such as receiving power of uplink transmission, signal quality of uplink transmission, distance of user equipment from a base station. FIG. 7 also shows network equipment 742 to 748 that provides transmission to another sector of the network. The functionality of the equipment 724 to 748 can be identical to the functionality of the equipment 722 to 728 transmitting/receiving to/from the first sector of the base station.

In one embodiment of the invention, frequency-hopping algorithms can be combined with the inventive idea regarding the use of FFL's. Then, the frequencies used in the frequency hopping algorithms can continuously repeat the order of FFL.

In still another embodiment of the invention, one or more logical data flows can be attached to the frequencies in the FFL's. For instance, the user data can be interleaved over all or only some of the frequencies in the FFL.

The invention can be implemented as software in a digital signal processor. Alternatively, the invention can be provided by ASIC (Application Specific Integrated Circuit), by logic components or in some corresponding manner.

It will be obvious to a person skilled in the art that as technology advances, the inventive concept can be implemented in various ways. The invention and its embodiments are not limited to the examples described above but may vary within the scope of the claims.

1. A method of allocating frequencies on the uplink of a radio network, the method including:
allocating a same set of uplink frequencies to each of two adjacent coverage areas of the network, wherein the set of uplink frequencies is allocated according to a different allocating priority in the two adjacent coverage areas.

2. The method according to claim 1, wherein the set of uplink frequencies includes one uplink primary frequency that is primarily allocated to a terminal residing in the sector, wherein the primary frequency is different for each of the two adjacent coverage areas.

3. The method according to claim 1, wherein the set of uplink frequencies includes at least one secondary uplink frequencies that are secondarily allocated to a terminal residing in each of the coverage areas, wherein an allocation priority of the at least one secondary frequency is different in two adjacent coverage areas.

4. A radio network, wherein the network is configured to use a same set of uplink radio frequencies in each of two adjacent coverage areas of the network, and wherein the network is configured to allocate the uplink frequencies in each of the adjacent coverage areas according to a different allocation priority.

5. The radio network according to claim 4, wherein the set of uplink frequencies includes one uplink primary frequency that is primarily allocated to a mobile terminal residing in any one of the two adjacent coverage areas, wherein the primary frequency is different for each of the two adjacent coverage areas.

6. The radio network according to claim 5, wherein the network is a macro cell network, the macro cell network including at least one of a micro cell network or a pico cell network within a coverage area of the macro cell network, wherein the allocation priority of frequencies in a coverage area of the micro cell network is such that the primary frequency of the coverage area of the macro cell network is allocated as a last uplink frequency.

7. The radio network according to claim 4, wherein the set of uplink frequencies includes at least one secondary frequencies that are secondarily allocated to a terminal residing in any one of the two adjacent coverage areas, wherein an allocation priority of the at least one secondary frequency is different in each of the two adjacent coverage areas.

8. The radio network according to claim 4, wherein the set of uplink frequencies for a certain coverage area includes a fixed primary frequency, which is a frequency that is to be allocated first in the coverage area, and at least one secondary frequency, which is allocated secondarily after the allocation of the primary frequency, the at least one secondary frequency being dynamically arranged into an allocation priority depending on interference in the network.

9. The radio network according to claim 8, wherein the network is configured to determine the interference in the network from measurement reports that are received from mobile terminals using the network.

10. The radio network according to claim 8, wherein the network is configured to determine the interference in the network from measurement reports that are formed in base stations of the network.

11. The radio network according to claim 8, wherein the network is configured to determine the interference in the network from measurement reports that are formed in mobile terminals using the network and in base stations of the network.

12. The radio network according to claim 8, wherein the network is configured to determine the interference in the network from information obtained from an allocation of frequencies in the network.

13. The radio network according to claim 4, wherein each of the two adjacent coverage areas includes a sector.

14. The radio network according to claim 4, wherein each of the two adjacent coverage areas includes a cell.

15. The radio network according to claim 4, wherein the set of uplink frequencies includes a frequency sub-band in a multi-carrier code division multiple access network.

16. The radio network according to claim 4, wherein the set of uplink frequencies includes a group of sub-carriers in an orthogonal frequency division multiplexing system.

17. A radio network element, comprising:
means for communicating, in a first coverage area, with a mobile terminal by applying a primary frequency;
means for communicating, in the first coverage area, with the mobile terminal by applying at least one secondary frequencies, if the mobile terminal can support the at least one secondary frequency and requests one of the at least one secondary uplink frequencies, wherein,
the radio network element is configured to allocate the primary frequency and at least one of the at least one secondary frequencies from a set of frequencies, the set of frequencies being the same set of frequencies available for allocation in a second coverage area that is next to the first coverage area, wherein an allocation priority of the frequencies in the set of frequencies is different in the first coverage area compared to an allocation priority of frequencies in the second coverage area.

18. The radio network element according to claim 17, wherein the network element comprises:
means for estimating one or more properties relating to the primary frequency; and
means for deciding, upon estimation, if the mobile terminal can support at least one secondary frequency.

19. The radio network element according to claim 17, wherein the network element includes a base station.

20. The radio network element according to claim 19, wherein the first and second coverage areas are provided by the same base station.

21. The radio network element according to claim 19, wherein the first and second coverage areas are provided by different base stations.

22. The radio network element according to claim 17, wherein the set of frequencies for each of the coverage areas includes a fixed primary frequency, which is a frequency that is to be allocated first in the coverage area, and at least one dynamically allocated secondary frequency being allocated secondarily after the allocation of the primary frequency, the at least one secondary frequency being dynamically arranged into an allocation priority depending on interference in a radio network.

23. The radio network element according to claim 17, wherein the coverage area includes a first sub coverage area for applying the primary frequency only, and at least one second sub-coverage area for applying at least one of the secondary frequencies, wherein the at least one second sub-coverage area is closer to the network element than the first sub-coverage area.

24. A cell base station, wherein the cell base station is either one of a micro cell base station or a pico cell base station, the cell base station comprising means for providing a radio cell, wherein the radio cell is in an operation area of a macro cell, the cell base station being configured to use a same set of frequencies as a macro cell network, wherein an allocation priority of the frequencies in the cell base station is such that a primarily allocated frequency of the macro cell has a lowest allocation priority in the radio cell.

25. A mobile terminal, comprising:
means for setting up a first uplink connection to a mobile network;
means for evaluating at least one property associated with the first uplink connection; and
means for deciding whether one or more second uplink connections are sent to the network depending upon the at least one property.

26. A computer program embodied on a computer-readable medium, said computer program including instructions for executing a computer process of allocating frequencies on the uplink of a radio network, the process including:
allocating a same set of uplink frequencies used in two adjacent coverage areas of the network, wherein the set of uplink frequencies is allocated according to a different allocating priority in the two adjacent coverage areas.
